(19) United States
(12) Patent Application Publication
(10) Pub. No.: US 2019/0014868 A1
(43) Pub. Date: Jan. 17, 2019

(54) EARRING SUPPORT SYSTEM

(71) Applicant: April Assadbeigi, Vancouver (CA)

(72) Inventor: April Assadbeigi, Vancouver (CA)

(21) Appl. No.: 15/646,691

(22) Filed: Jul. 11, 2017

(51) Int. Cl. A44C 7/00; F16M 13/04

(52) U.S. Cl. CPC A44C 7/00; F16M 13/04

(57) ABSTRACT

An earring support system including an earring support device having a substantially c-shaped support member which is configured to contour along an outer periphery of an ear about a root of the ear of a user-wearer, and an aperture configured to receive an earring. The c-shaped support member is configured to relieve stress of a weight of the earring on the ear of the user-wearer and eliminate any pulling or tearing of an ear lobe, due to weight.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of ear lobe supports and more specifically relates to an earring support device.

### 2. Description of Related Art

An earring is a piece of jewelry attached to an ear via a piercing in an ear lobe or another external part of the ear. Earring components may be made of any number of materials, including metal, plastic, glass, precious stone, beads, wood, bone, and other materials. Designs range from small loops and studs to large plates and dangling items. The size is ultimately limited by the physical capacity of the ear lobe to hold the earring without tearing. However, heavy earrings worn over extended periods of time may lead to stretching of the ear lobe and the piercing. A suitable solution is desired.

U.S. Pub. No. 2010/0212356 to Tosiki Namiki relates to a supporting earring along root of ear. The described supporting earring along root of ear includes an earring that can be easily put on an ear without coming off during a use thereof and causes no pains in the ear lobe of the ear. Moreover, the earring can give a gorgeous decorative feeling. The earring includes a supporting portion formed in a shape of a letter c to be put along a root of a human ear and a decorative body provided at an end of the supporting portion, wherein one end of the supporting portion is caught by an upper end of the ear, and a central part of the supporting portion abuts against a reverse side of the root of the ear. The decorative body is exchangeable.

### BRIEF SUMMARY OF THE INVENTION

In view of the foregoing disadvantages inherent in the known ear lobe support art, the present disclosure provides a novel earring support system. The general purpose of the present disclosure, which will be described subsequently in greater detail, is to provide a lightweight plastic hook, with a small aperture for the hanging or placement of a heavy ear ring. The support will eliminate any pulling or tearing of the ear lobe; the pulling caused due to the weight (mass) of the earring.

An earring support system is disclosed herein. The earring support system may include an earring support device having a substantially c-shaped support member which is configured to contour along an outer periphery of an ear about a root of the ear of a user-wearer, and an aperture configured to receive an earring. The c-shaped support member may comprise a substantially cylindrical profile. The c-shaped support member further comprises a first-end and a second-end, the first-end occupying a position on top of the ear and the second-end occupying a position at an ear lobe when used (worn). The second-end of the c-shaped support member comprises the aperture. The aperture when in an in-use condition is adjacent a center portion of a back side of the ear lobe. The c-shaped support member is configured to relieve stress of a weight (mass) of the earring on the ear of the user-wearer and effectively eliminate any pulling or tearing of the ear lobe. The earring support system provides lifting action of about 1 cm when using the ear support. The appearance of torn ear lobes is thereby minimized and often concealed.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an earring support system, constructed and operative according to the teachings of the present disclosure.

FIG. 1 is a perspective view of the earring support system during an ‘in-use’ condition, according to an embodiment of the disclosure.

FIG. 2 is a perspective view of the earring support system of FIG. 1, according to an embodiment of the present disclosure.

FIG. 3 is a perspective view of the earring support system of FIG. 1, according to an embodiment of the present disclosure.

FIG. 4 is a perspective view of the earring support system of FIG. 1, according to an embodiment of the present disclosure.

FIG. 5 is a perspective view of the earring support system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an ear lobe support and more particularly to an earring support system as used to relieve stress of a weight of an earring on the ear of the user-wearer and reduce stretching and tearing of ear lobes.

Generally, the present invention includes a lightweight plastic hook which may be used to support a heavy earring and reduce pulling or tearing of an ear lobe. The device may be a transparent plastic or other suitable material for providing an almost ‘invisible’ appearance. The earring support system may be provided in various colors based on user-preference. The earring support system is unisex and accommodates ears of all sizes. The present invention provides lifting action of about 1 cm when using the ear support. The appearance of torn ear lobes is thereby minimized and often concealed.

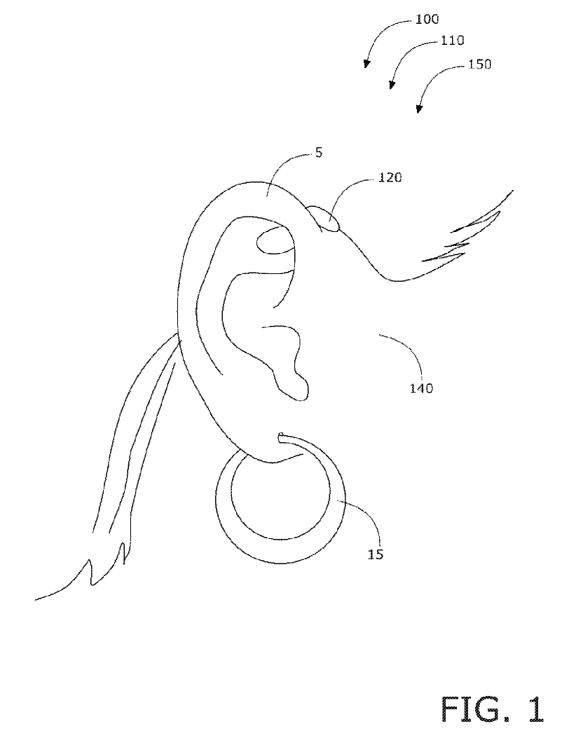

Referring now more specifically to the drawings by numerals of reference, there is shown in FIGS. 1-5, various views of an earring support system 100. FIG. 1 shows an earring support system 100 during an ‘in-use’ condition 150, according to an embodiment of the present disclosure. As illustrated, the earring support system 100 may include an earring support device 110 having a substantially c-shaped support member 120 which is configured to contour along an outer periphery of an ear 5 about a root of the ear 5 of a user-wearer 140, and an aperture 130 configured to receive an earring 15.

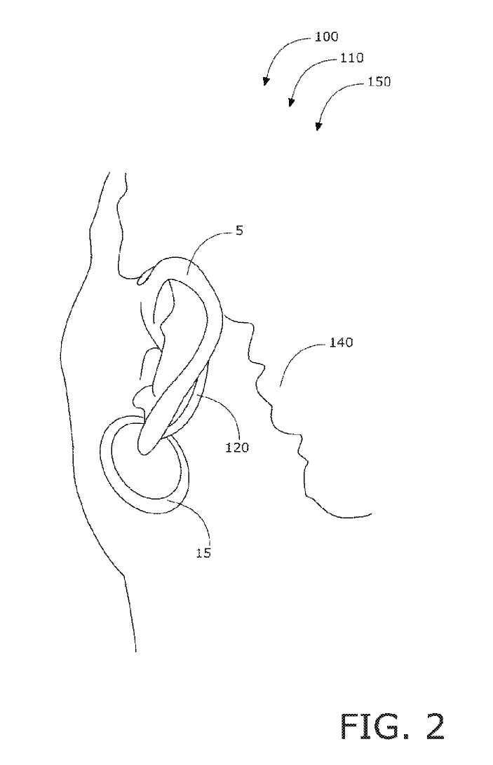

FIG. 2 shows a perspective view of the earring support system 100 of FIG. 1, according to an embodiment of the present disclosure. As above, the earring support system 100 may include an earring support device 110 having a substantially c-shaped support member 120 and an aperture 130 configured to receive an earring 15. The earring support device 110 comprises the c-shaped support member 120 and the aperture 130. The c-shaped support member 120 is configured to relieve stress of a weight of the earring 15 on the ear 5 of the user-wearer 140.

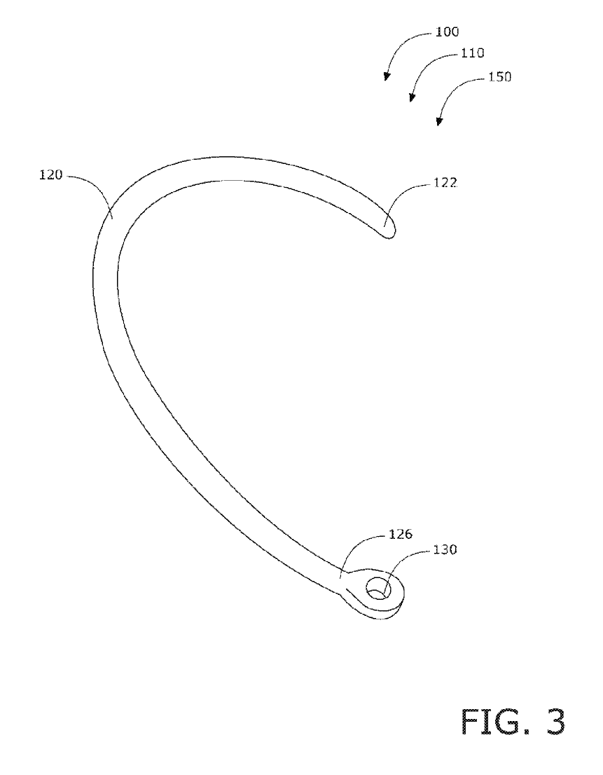

FIG. 3 shows a perspective view of the earring support system 100 of FIG. 1, according to an embodiment of the present disclosure. As above, the earring support system 100 may include an earring support device 110 having a substantially c-shaped support member 120 and an aperture 130. In a preferred embodiment, the earring support device 110 is preferably transparent. In other embodiments, the earring support device 110 may be non-transparent and include various colors such as skin tones. The c-shaped support member 120 may be rigid and is configured to support the weight of the earring 15 and reduce stretching of an ear lobe. The aperture 130 is positioned relative and adjacent to a lower portion of the ear lobe of the ear 5 of the user-wearer 140. The c-shaped support member 120 may comprise light-weight plastic. The earring support device 110 may be bisphenol A free and flame resistant to approximately 180 degrees Celsius.

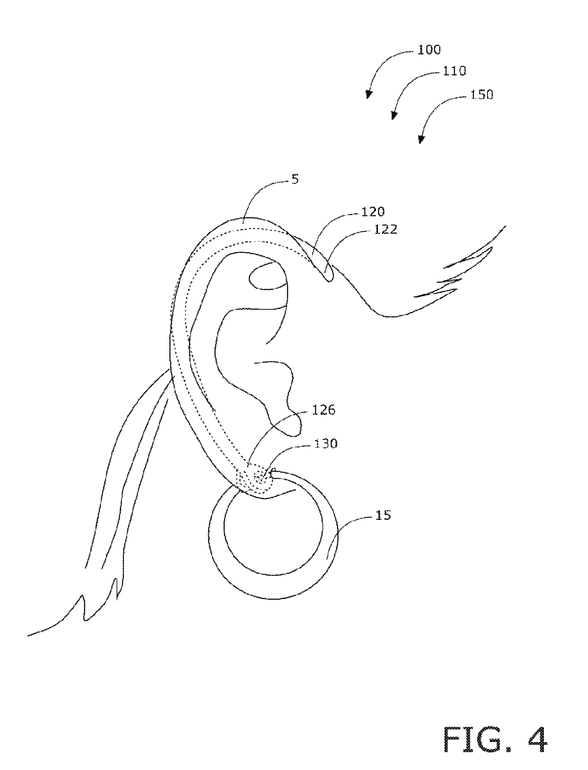

FIG. 4 shows a perspective view of the earring support system 100 of FIG. 1, according to an embodiment of the present disclosure. As above, the earring support system 100 may include an earring support device 110 having a substantially c-shaped support member 120 and an aperture 130 configured to receive at least one earring 15. The c-shaped support member 120 comprises a first-end 122 and a second-end 126; the first-end 122 occupying a position on top of the ear 5 and the second-end 126 occupying a position at the ear lobe. The second-end 126 of the c-shaped support member 120 comprises the aperture 130. The aperture 130 when in an in-use condition is adjacent a center portion of a back side of the ear lobe. In other embodiments, the aperture 130 when in an in-use condition is adjacent a front side of the ear lobe to provide support for a weight of the earring 15 on the ear 5 of the user-wearer 140. The first-end 122 comprises a substantial curve for securing and hooking the c-shaped support member 120 to the top of the ear 5.

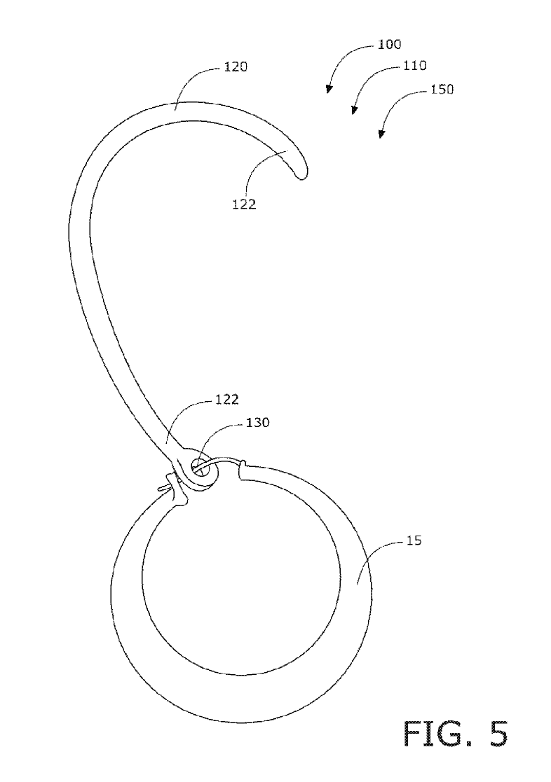

FIG. 5 shows a perspective view of the earring support system 100 of FIG. 1, according to an embodiment of the present disclosure. As above, the earring support system 100 may include an earring support device 110 having a substantially c-shaped support member 120 which is configured to contour along an outer periphery of an ear 5 about a root of the ear 5 of a user-wearer 140, and an aperture 130 configured to receive an earring 15. The earring support device 110 preferably comprises a length of approximately 8.5 centimeters. The earring support device 110 preferably comprises a width of approximately 0.25 centimeters. The c-shaped support member 120 comprises a substantially cylindrical profile.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. An earring support system, the earring support system comprising:
a rigid-bisphenol A free-plastic earring support device having;
a substantially c-shaped support member comprises a substantially cylindrical profile throughout a length of said substantially c-shaped support member and wherein said substantially c-shaped support member is configured to contour along an outer periphery of an ear of a user-wearer; and said substantially c-shaped support member comprises an aperture configured to receive an earring;
wherein said c-shaped support member is configured to relieve stress of a weight of said earring on said ear of said user-wearer and further configurated to lift an ear lobe of said user-wearer.

2. The earring support system of claim 1, wherein said rigid-bisphenol A free-plastic earring support device is transparent.

3. The earring support system of claim 1, wherein said rigid-bisphenol A free-plastic earring support device is non-transparent.

4. The earring support system of claim 1, wherein said c-shaped support member is rigid-non-bendable and configured to support said weight of said earring and reduce stretching of an ear lobe and further provide lifting action of said earlobe of 1 centimeter.

5. The earring support system of claim 4, wherein said aperture is positioned relative and adjacent to a lower portion of said ear lobe of said ear of said user-wearer.

6. The earring support system of claim 1, wherein said c-shaped support member comprises plastic.

7. (canceled)

8. The earring support system of claim 1, wherein said rigid-bisphenol A free-plastic earring support device is plastic that is flame resistant to 180 degrees celsius.

9. The earring support system of claim 1, wherein said c-shaped support member comprises a first-end and a second-end, said first-end occupying a position on top of said ear and said second-end occupying a position at said ear lobe.

10. The earring support system of claim 9, wherein said second-end of said c-shaped support member comprises said aperture.

11. The earring support system of claim 1, wherein said aperture when in an in-use condition is adjacent a center portion of a back side of said ear lobe.

12. The earring support system of claim 1, wherein said aperture when in an in-use condition is adjacent a front side of said ear lobe.

13. The earring support system of claim 9, wherein said first-end comprises a substantial curve for securing said c-shaped support member to said top of said ear.

14. The earring support system of claim 1, wherein said rigid-bisphenol A free-plastic earring support device comprises a length of 8.5 centimeters.

15. The earring support system of claim 1, wherein said rigid-bisphenol A free-plastic earring support device comprises a width of 0.25 centimeters.

16. (canceled)

17. An earring support system, the earring support system comprising:
a rigid-bisphenol A free-plastic earring support device having;
a substantially c-shaped support member which is configured to contour along an outer periphery of an ear of a user-wearer; and
an aperture configured to receive an earring;
wherein said c-shaped support member is configured to support said weight of said earring and reduce stretching of an ear lobe;
wherein said c-shaped support member comprises a substantially cylindrical profile;
wherein said aperture is positioned relative and adjacent to a lower portion of said ear lobe of said ear of said user-wearer;
wherein said rigid-bisphenol A free-plastic earring support device is transparent;
wherein said rigid-bisphenol A free-plastic earring support device is flame resistant to 180 degrees Celsius;
wherein said c-shaped support member comprises a first-end and a second-end, said first-end occupying a position on top of said ear and said second-end occupying a position at said ear lobe;
wherein said second-end of said c-shaped support member comprises said aperture;
wherein said aperture when in an in-use condition is adjacent a center portion of a back side of said ear lobe;
wherein said first-end comprises a substantial curve for securing said c-shaped support member to said top of said ear;
wherein said rigid-bisphenol A free-plastic earring support device comprises a length of 8.5 centimeters;
wherein said rigid-bisphenol A free-plastic earring support device comprises a width of 0.25 centimeters; and
wherein said c-shaped support member is configured to relieve stress of a weight of said earring on said ear of said user-wearer.
